(19) United States
(12) Patent Application Publication
(10) Pub. No.: US 2009/0169896 A1
(43) Pub. Date: Jul. 2, 2009

(54) Sheet with hard coating and associated methods

(76) Inventors: Ho Seok Sohn, Uiwang-si (KR); Hyun Don Kim, Uiwang-si (KR); Dae Kyu Lee, Uiwang-si (KR); Hyun Suk Yu, Uiwang-si (KR)

Correspondence Address: LEE & MORSE, P.C., 3141 FAIRVIEW PARK DRIVE, SUITE 500, FALLS CHURCH, VA, 22042, US

(21) Appl. No.: 12/318,450

(22) Filed: Dec. 30, 2008

(30) Foreign Application Priority Data
Dec. 31, 2007 (KR) 10-2007-0141679

(51) Int. Cl. B32B 27/36; B32B 27/28; B05D 7/04

(52) U.S. Cl. 428/412; 428/421; 427/412.5

(57) ABSTRACT

Disclosed herein is a plastic sheet with good anti-fouling properties, impact resistance, anti-static properties, and scratch resistance. The plastic sheet includes a transparent substrate, a first hard coat layer comprising a fluoroacrylate copolymer on one surface of the transparent substrate, and a second hard coat layer comprising a bisphenol-based resin and a conductive filler on the other surface of the transparent substrate.

### BACKGROUND OF THE INVENTION

1. Field of the Invention

Embodiments relate to a sheet with a hard coating and associated methods.

2. Description of the Related Art

Functional hard coatings may be used to protect the surface of products such as construction materials, exterior vehicle components, paper, wood, furniture, soundproof walls, optical materials, cosmetic containers, display devices, etc., from exterior environments. Functional hard coatings may be used to protect the surface of a sheet, e.g., a plastic sheet, used for various electronic appliances including, e.g., display devices such as liquid crystal displays (LCDs), plasma display panels (PDPs), projection televisions, or for screens of mobile phones, and may prevent the surface of the sheet from scratches, etc. Typically, however, hard coating compositions are developed solely to improve scratch resistance of the hard coatings, and may be inferior in terms of anti-fouling properties, thermal resistance, impact resistance, etc. Thus, there is a need for advances in the development of hard coatings that provide the advantages of traditional hard coating layers as well as other advantages such as anti-fouling properties, thermal resistance, impact resistance, etc.

### SUMMARY OF THE INVENTION

Embodiments are therefore directed to a sheet with a hard coating and associated methods, which substantially overcome one or more of the problems due to the limitations and disadvantages of the related art.

It is therefore a feature of an embodiment to provide a sheet with a hard coating and associated methods, which provide good anti-fouling properties, impact resistance, anti-static properties, and scratch resistance.

At least one of the above and other features and advantages may be realized by providing a sheet with a hard coating, including a transparent substrate, a first hard coat layer on a first surface of the transparent substrate, the first hard coat layer including a fluoroacrylate copolymer, and a second hard coat layer on a second surface of the transparent substrate, the second hard coat layer including a conductive filler in a bisphenol-based polymer.

The first hard coating may be formed from a first hard coating composition that includes about 5 to about 50% by weight of the fluoroacrylate copolymer, about 5 to about 40% by weight of an acrylic monomer, about 0.1 to about 5% by weight of a photo-initiator, and an organic solvent as the remaining balance of the weight of the first hard coating composition. The acrylic monomer may not have a cyclic aliphatic structure.

The second hard coating layer may be formed from a second hard coating composition that includes about 1 to about 15% by weight of a bisphenol-based resin, about 1 to about 10% by weight of the conductive filler, about 5 to about 40% by weight of an acrylic monomer, about 0.1 to about 5% by weight of a photo-initiator, and an organic solvent as the remaining balance of the weight of the second hard coating composition.

The second hard coating composition may further include about 1 to about 10% by weight of a thermally resistant resin. The thermally resistant resin may include one or more of a polyphenylsilsesquioxane resin, PPZ (a phosphazene-based monomer bearing six methacrylate functional groups), and a blend of PPZ-dipentaerythritol hexacrylate.

The bisphenol-based resin may have a refractive index of about 1.50 or more. The first hard coating composition may further include about 1 to about 15% by weight, based on the weight of the first hard coating composition, of a bisphenol-based resin having a refractive index of about 1.50 or more.

The first hard coating composition may further include a photo-stabilizer, and the second hard coating composition may further include a photo-stabilizer. The conductive filler may include one or more of a perfluoroalkyl group-containing cationic surfactant, a polyether/polyolefin block copolymer, a lithium salt, a multifunctional acrylate oligomer with ionic groups, and a poly(3,4-ethylenedioxythiophene)/(polystyrene sulfonate) ethanol dispersion.

The transparent substrate may include one or more of a polymeric acrylic component, a polymeric polycarbonate component, a polymeric polymethyl methacrylate component, a methyl methacrylate-styrene copolymer component, and a polymeric acrylonitrile butadiene styrene component. The transparent substrate may include first and second polymeric acrylic layers, and a polymeric polycarbonate layer between the first and second polymeric acrylic layers.

At least one of the above and other features and advantages may also be realized by providing a method of forming a sheet having a hard coating, the method including forming a first hard coat layer on a first surface of a transparent substrate, the first hard coat layer including a fluoroacrylate copolymer, and forming a second hard coat layer on a second surface of the transparent substrate, the second hard coat layer including a conductive filler in a bisphenol-based polymer.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a perspective view of a transparent sheet with hard coat layers on the surface thereof according to an embodiment;

FIG. 2 illustrates Table 1, listing components used in the Examples and Comparative Examples; and

FIG. 3 illustrates Table 2, listing properties of sheets prepared according to the Examples and Comparative Examples.

### DETAILED DESCRIPTION OF THE INVENTION

Korean Patent Application No. 10-2007-0141679, filed on Dec. 31, 2007, in the Korean Intellectual Property Office, and entitled: “Plastic Sheet Comprising Hard Coat Layer,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

As used herein, the expressions “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” includes the following meanings: A alone; B alone; C alone; both A and B together; both A and C together; both B and C together; and all three of A, B, and C together. Further, these expressions are open-ended, unless expressly designated to the contrary by their combination with the term “consisting of:” For example, the expression “at least one of A, B, and C” may also include an nth member, where n is greater than 3, whereas the expression “at least one selected from the group consisting of A, B, and C” does not.

As used herein, the expression “or” is not an “exclusive or” unless it is used in conjunction with the term “either.” For example, the expression “A, B, or C” includes A alone; B alone; C alone; both A and B together; both A and C together; both B and C together; and all three of A, B, and C together, whereas the expression “either A, B, or C” means one of A alone, B alone, and C alone, and does not mean any of both A and B together; both A and C together; both B and C together; and all three of A, B, and C together.

As used herein, the terms “a” and “an” are open terms that may be used in conjunction with singular items or with plural items. For example, the term “a solvent” may represent a single compound, e.g., isopropanol, or multiple compounds in combination, e.g., isopropanol mixed with methyl cellosolve.

As used herein, molecular weights of polymeric materials are weight average molecular weights, unless otherwise indicated.

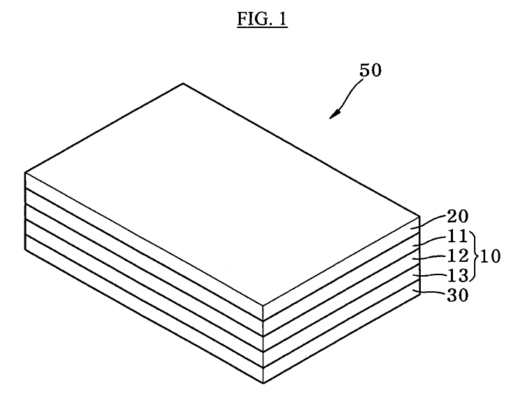

FIG. 1 illustrates a perspective view of a sheet 50 with hard coat layers on the surface thereof according to an embodiment.

Referring to FIG. 1, the sheet 50 may be, e.g., a plastic sheet. The sheet 50 may include a transparent substrate 10, a first hard coat layer 20 on one surface of the transparent substrate 10, and a second hard coat layer 30 on the other surface of the transparent substrate 10.

According to embodiments, the first hard coat layer 20 may include a fluoroacrylate copolymer, and the second hard coat layer 30 may include a conductive filler in a bisphenol-based polymer. The polymeric bisphenol-based component may be combined with additional polymeric components, e.g., a thermally resistant polymer component such as polymeric polyphenylsilsesquioxane resin, polymeric PPZ (a phosphazene-based monomer bearing six methacrylate functional groups), and/or a polymeric blend of PPZ-dipentaerythritol hexacrylate.

<Transparent Substrate 10>

The transparent substrate 10 may be a polymeric material formed from a transparent plastic resin, e.g., one or more of an acrylic resin, a polycarbonate resin, a polymethyl methacrylate resin, a methyl methacrylate-styrene copolymer resin, an acrylonitrile butadiene styrene (ABS) resin, etc.

In an implementation, the transparent substrate 10 may be formed by laminating two or more transparent substrates formed from transparent resins such as those described above. For example, referring to FIG. 1, the transparent substrate 10 may be an laminate of acryl resin/polycarbonate resin/acryl resin layers, i.e., the transparent substrate 10 may include an acryl first transparent sub-substrate 11, a polycarbonate second transparent sub-substrate 12, and an acryl third transparent sub-substrate 13, sequentially laminated.

The acryl first and third transparent sub-substrates 11 and 13 may provide surface hardness and good optical properties. Further, the polycarbonate second transparent sub-substrate 12 may provide good impact resistance and thermal resistance. Accordingly, when these first to third transparent sub-matrices 11, 12 and 13 are stacked to form the transparent substrate 10, the transparent substrate 10 may exhibit all of the aforementioned properties.

The transparent substrate 10 may have a thickness of, e.g., about 0.1 mm to about 10 mm.

<First Hard Coat Layer 20>

The first hard coat layer 20 may be disposed on a first surface of the transparent substrate 10. The first hard coat layer 20 may serve to impart anti-fouling properties such as resistance to stains from, e.g., oil-based ink markers, fingerprints, etc., and may also impart impact resistance and scratch resistance to the sheet.

The first hard coat layer 20 may be formed from a first hard coating composition that includes a fluoroacrylate copolymer, an acrylic monomer, a photo-initiator, and an organic solvent.

The fluoroacrylate copolymer may be a copolymer in which a substituent group of a fluorine-containing compound is bonded to the backbone of an acrylate resin having three or more functional groups. The first hard coating composition may include about 5% to about 50% by weight of the fluoroacrylate copolymer. Maintaining the content of fluoroacrylate copolymer at about 5% by weight or more may help ensure sufficient anti-fouling properties, and maintaining the content of fluoroacrylate copolymer at about 50% by weight or less may help ensure that scratch resistance and wear resistance of the hard coat layer is not deteriorated.

The acrylic monomer contained in the first hard coat layer 20 may be an acrylic monomer that does not have a cyclic aliphatic structure. The acrylic monomer may include one more of, e.g., mono-functional group acrylic monomer, di-functional group acrylic monomer, and a tri- or more multi-functional group acrylic monomer. Examples of the mono-functional group acrylic monomer include, e.g., butyl acrylate, allyl methacrylate, 2-methoxyethylacrylate, 2-hydroxyethylmetacrylate, etc. Examples of the di-functional group acrylic monomer include, e.g., 1,6-hexanedioldiacrylate (HDDA), 1,3-butyleneglycoldimethacrylate (BGMDA), tripropyleneglycoldiacrylate (TPGDA), etc. Examples of the tri- or more multi-functional group acrylic monomer include, e.g., trimethylolpropanetriacrylate (TMPTA), pentaerythritoltriacrylate (PETA), dipentaerythritol hexacrylate (DPHA), etc. The hard coating composition may include about 5 to about 40% by weight of the acrylic monomer. Maintaining the content of acrylic monomer at about 5% by weight or more may help ensure that the hardness of the hard coat layer is high, and maintaining the content of acrylic monomer at about 40% by weight or less may help ensure that the hardness of the hard coat layer does not become excessively high.

In an implementation, the hard coating composition may further include a fluorinated acrylic monomer, a urethane acrylic monomer, an oligomer, etc., as appropriate to control the viscosity of the composition and/or to enhance the anti-fouling properties.

The photo-initiator may be used for UV-curable (ultraviolet light-curable) compositions. Examples of the photo-initiator include, e.g., benzophenone-based materials such as 1-hydroxy-cyclohexyl-phenylketone (Irgacure 184), α,α-dimethoxy-α-hydroxyacetophenone (Darocure 1173), and blends of 1-hydroxy-cyclohexyl-phenylketone benzophenone; and materials such as 2-hydroxy-2-methyl-1-phenyl propane, etc. The hard coating composition may include about 0.1 to about 5% by weight of the photo-initiator. Maintaining the content of photo-initiator at about 0.1% by weight or more may help ensure that the hard coat layer is sufficiently hardened, and maintaining the content of photo-initiator at about 5% by weight or less may help ensure that the photo-initiator does not remain as an impurity in the hard coat layer, which could lower the hardness of the coat layer.

The use, type, and amount of organic solvent may be determined in consideration of coatability of the hard coating composition, a drying rate thereof, and an appearance or yield of products. The organic solvent may include one or more of, e.g., methanol, ethanol, isopropanol, n-propanol, butanol, isobutanol, ethyl cellosolve, methyl cellosolve, butyl cellosolve, butyl acetate, ethyl acetate, diacetone alcohol, methylethylketone, propyleneglycol isopropyl alcohol, ethyleneglycol isopropyl alcohol, etc.

In an implementation, the first hard coating composition may further include a bisphenol-based resin to improve clearness and remove coating stains. For example, the first hard coating composition may include a bisphenol-based resin having a refractive index of 1.50 or more. The bisphenol-based resin may include, e.g., a diacrylate resin of ethylene oxide-modified bisphenol A. The first hard coating composition may include about 1% to about 15% by weight of the bisphenol-based resin. Maintaining the content of bisphenol-based resin at about 1% by weight or more may help ensure that the effects provided by the bisphenol-based resin are significant, and maintaining the content of bisphenol-based resin at about 15% by weight or less may help ensure that the coat layer can has a high surface hardness.

In an implementation, the first hard coating composition may further include a photo-stabilizer. The photo-stabilizer may enhance photo stability of the hard coating, e.g., enhance resistance to degradation from UV light, thereby preventing variation of the properties of the hard coating with time. The photo-stabilizer may be suitably selected according to the kind of the photo-initiator used. For example, if the photo-initiator used is a benzophenone-based material such as α,α-dimethoxy-α-hydroxyacetophenone (Darocure 1173), etc., the photo-stabilizer may be, e.g., bis-(1-octyloxy-2,2,6,6-tetramethyl-4-piperidinyl)sebacate (marketed as Tinuvin 123), etc. The content of photo-stabilizer may be about 0.01% to about 1% by weight, based on the total weight of the first hard coating composition.

In an implementation, the first hard coating composition may further include other additive agents, such as leveling agents, UV-absorbent agents, surfactants, etc., as needed.

The first hard coating composition may have a viscosity of about 1 to about 100 cps at 25° C., which may provide a good level of fluidity for the first hard coating composition to enhance productivity in formation of the hard coating.

The first hard coating composition may provide not only good productivity in the formation of the first hard coat layer, but also good properties for the first hard coat layer in terms of anti-fouling properties, impact resistance, anti-static property, and scratch resistance.

<Second Hard Coat Layer 30>

The second hard coat layer 30 may be disposed on a surface of the transparent substrate 10 opposite the first hard coat layer 20. The second hard coat layer 30 may exhibit further enhanced optical properties such as transparency, anti-static properties, anti-electrostatic discharge property, good film hardness, etc.

The second hard coat layer may be formed from a second hard coating composition that includes a bisphenol-based resin, an acrylic monomer, a conductive filler, a photo-initiator, and an organic solvent. In the second hard coating composition, the bisphenol-based resin, the acrylic monomer, the photo-initiator, the organic solvent, and the photo stabilizer, may be the same as the respective materials of the first hard coat layer 20 described above.

The second hard coat composition may include the conductive filler to impart anti-electrostatic discharge (anti-ESD) properties. Examples of the conductive filler include, e.g., a perfluoroalkyl group-containing cationic surfactant, a polyether/polyolefin block copolymer, a lithium salt, a multifunctional acrylate oligomer with ionic groups, a poly(3,4-ethylenedioxythiophene)/(polystyrene sulfonate) ethanol dispersion, etc. For example, the second hard coat composition may include the poly(3,4-ethylenedioxythiophene)/(polystyrene sulfonate) ethanol dispersion as the conductive filler. The content of conductive filler may be about 1% to about 10% by weight, based on the total amount of the second hard coating composition. Maintaining the content of conductive filler at about 1% by weight or more may help ensure that sufficient anti-electrostatic discharge properties are realized in the coat layer, and maintaining the content of conductive filler at about 10% by weight or less may help avoid negative effects to the coat layer in terms of spot and surface hardness.

In an implementation, the second hard coating composition may further include about 1% to about 10% by weight of a thermally resistant resin, for improvement of thermal resistance. Examples of the thermally resistant resin include, e.g., a polyphenyl silsesquioxane resin, a phosphazene-based monomer bearing six methacrylate functional groups (PPZ), a blend of PPZ and DPHA (PPZ and dipentaerythritol hexacrylate), etc.

The second hard coating composition may further comprise a photo stabilizer and other additive agents, e.g., such as those described above in connection with the first hard coating composition.

The second hard coat layer 30 formed using the second hard coating layer described above may provide additional enhancements in optical properties, anti-static properties, anti-electrostatic discharge properties, good film hardness, etc. The plastic sheet 50 may include the first hard coat layer 20, which may exhibit excellent anti-fouling properties, impact resistance and scratch resistance, formed on the one surface thereof, and the second hard coat layer 30, which may exhibit impact absorption, anti-static properties, and good transparency resulting from prevention of spot generation by the use of a high reflectivity resin, formed on the opposite surface thereof. Thus, the plastic sheet 50 according to this embodiment may exhibit very good properties in terms of anti-fouling properties, impact resistance, scratch resistance, impact absorption, transparency, and anti-static properties. Accordingly, the plastic sheet 50 having the hard coat layer may be suitable for application to interior or exterior panels of mobile phone terminals, protection panels of medical instruments, protection panels for a variety of display devices, such as LCDs, PDPs, electroluminescent displays, field emission displays, etc.

A process of coating the hard coating compositions to fabricate the plastic sheet according to an embodiment will now be described.

First, the transparent substrate 10 may be prepared and sufficiently washed. An operation of removing oil and foreign matter remaining on the transparent substrate 10 may include, e.g., preheating the transparent substrate with a UV irradiator.

The viscosity of the first hard coating composition may be adjusted to about 1 to about 100 cps at 25° C., after which the first hard coating composition may be deposited on one surface of the transparent substrate 10. Deposition of the first hard coating composition may be performed by, e.g., dip-coating, flow-coating, spray-coating, roll coating, spin coating, gravure coating, etc.

Then, the transparent substrate 10 with the first hard coating composition deposited thereon may be dried at about 40-80° C. for about 1˜30 minutes, may be subjected to IR heating, etc., to remove any organic solvent that may remain in the first hard coating composition.

Next, UV light may be radiated to the transparent substrate 10, e.g., at a luminous quantity of about 300 to about 800 mJ/cm² using, e.g., a high voltage mercury lamp or a metal halide lamp according to a desired wavelength range of the ultraviolet light. The UV light may cure the deposited first hard coating composition, thereby forming the first hard coat layer 20 on the transparent substrate 10.

Coating of the second hard coating layer 30 may also be performed by the same process as that of the first hard coating composition.

The following Examples and Comparative Examples are provided in order to set forth particular details of one or more embodiments. However, it will be understood that the embodiments are not limited to the particular details described.

### Preparation of Hard Coating Solutions

### EXAMPLE 1

A fluoroacrylate copolymer and an acrylic monomer without a cyclic aliphatic structure were supplied to a plastic beaker capable of blocking light. While rapidly stirring these components in the plastic beaker, ethanol, isopropanol, n-propanol, and methyl cellosolve were added as organic solvents to the stirring components, followed by stirring for about 2 hours at room temperature, thereby providing an intermediate solution.

Then, dipentaerythritolhexacrylate was added to some of the intermediate solution in the plastic beaker, which in turn was stirred again for about 2 hours at room temperature, thereby providing a stirred solution.

The stirred solution was diluted with the aforementioned organic solvents, and added to the intermediate solution. Finally, a photo-initiator (Irgacure 184 and Darocure 1173) and a photo-stabilizer (Tinuvin 123) were further added to the intermediate solution, followed by stirring for about 1 hour to obtain a uniformly distributed solution, which in turn was filtered through a 0.5 to 1.2 micron filter to remove foreign matter from the solution, thereby providing a desired hard coating composition.

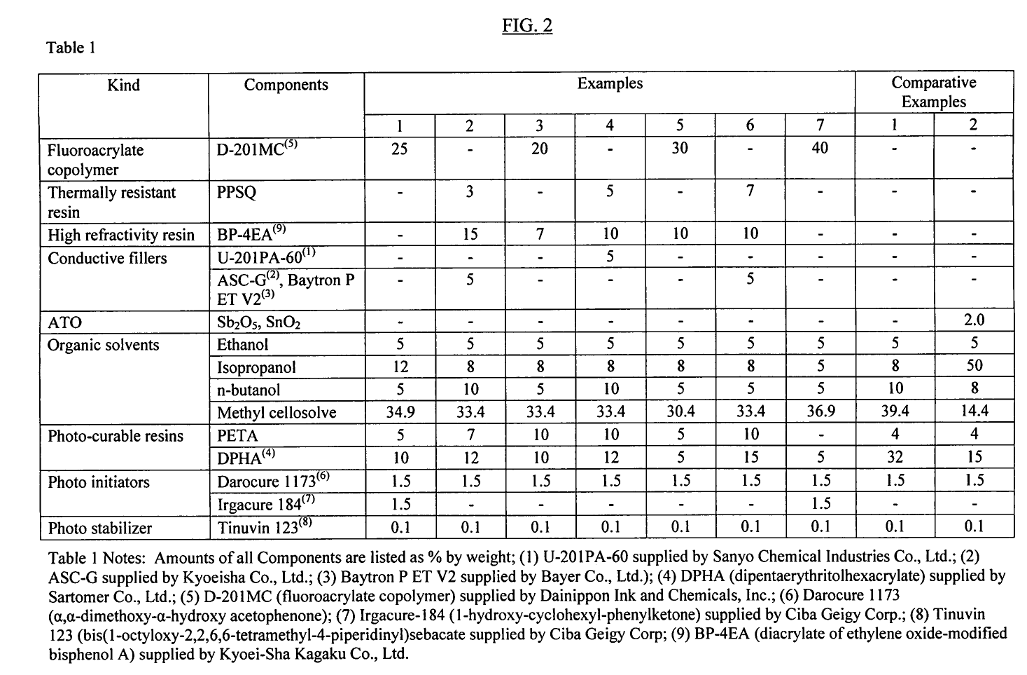

Table 1 in FIG. 2 lists components of the final hard coating composition.

### EXAMPLE 2

Example 2 was prepared using components listed in the Table 1. A bisphenol-based resin having a refractive index of 1.50 or more and an acrylic monomer having three functional groups or less were supplied to a plastic beaker capable of blocking light. Then, after a perfluoroalkyl group-containing cationic surfactant and a polyphenylsilsesquioxane resin were further added as the conductive filler and the thermally resistant resin to the plastic beaker, and ethanol, isopropanol, normal-propanol, and methyl cellosolve were added as organic solvents into the plastic beaker while rapidly stirring the contents thereof, followed by stirring for about 2 hours at room temperature, thereby providing an intermediate solution.

Then, dipentaerythritolhexacrylate was added to some of the intermediate solution in the plastic beaker, which in turn was stirred again for about 2 hours at room temperature, thereby providing a stirred solution.

The stirred solution was diluted with the aforementioned organic solvents, and added to the intermediate solution. Finally, a photo-initiator (Irgacure 184 and Darocure 1173) and a photo-stabilizer (Tinuvin 123) were further added to the intermediate solution, followed by stirring for about 1 hour to obtain a uniformly distributed solution, which in turn was filtered through a 0.5 to 1.2 micron filter to remove foreign matter from the solution, thereby providing a desired hard coating composition.

### EXAMPLES 3, 5, 7 AND COMPARATIVE EXAMPLE 1

Examples 3, 5, 7, and Comparative Example 1 were prepared by the same process as that of Example 1 using the components and compositional ratios listed in Table 1.

### EXAMPLES 4 AND 6

Examples 4 and 6 were prepared by the same process as that of Example 2 using the components and compositional ratios listed in Table 1.

### COMPARATIVE EXAMPLE 2

A commercially available hard coating composition containing ATO (antimony tin oxide) sol as the conductive filler was prepared as Comparative Example 2, the composition of which is listed in Table 1.

### Preparation of Hard Coat Sheets

Each of the hard coating compositions of Examples 1 to 7 and Comparative Examples 1 and 2 was deposited on a transparent plastic substrate, which was a laminated sheet of PMMA/PC/PMMA (where PMMA means polymethyl methacrylate and PC means polycarbonate) having a thickness of 1 mm. The compositions were each dried at about 60 to 75° C. for about 5 minutes by means of a high pressure mercury lamp to completely remove the organic solvents from the coating compositions, followed by radiation of ultraviolet light at a luminous quantity of about 500 to 600 mJ/cm² to prepare a hard coat sheet.

### Property Evaluation

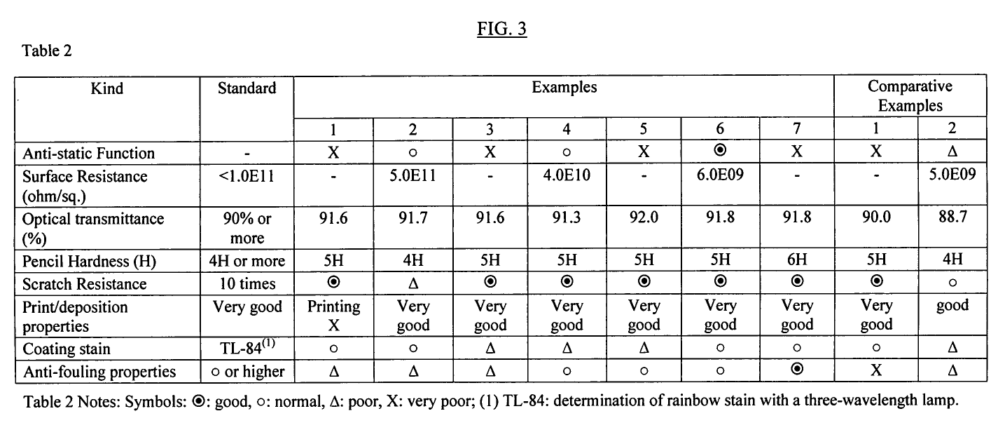

Table 2 in FIG. 3 lists the results of property evaluation with respect to the hard coat sheets prepared using Examples 1 to 7 and Comparative Examples 1 and 2. The property evaluation of each hard coat sheet was performed as follows.

(1) Impact Strength: Ball prop Tester (observation of cracks on the surface of the hard coat sheet after dropping 36 g ball at 50 cm height thereon).

(2) Anti-static Function: Appearance observation via evaluation of friction (attachment of foreign matter/dust) on a hard coating specimen.

(3) Surface Resistance: Measurement of surface resistance per unit area with a surface resistor (Mitsubishi Chemicals, Hiresta).

(4) Optical transmittance: Evaluation with a UV-visible (UV-VIS) spectrometer.

(5) Pencil Hardness: Evaluation via a method of ASTM D3502 (pencil hardness tester, Toyoseki).

(6) Scratch Resistance: Evaluation with Steel Wool #0000, 1 kg load, 10-time reciprocation.

(7) Anti-fouling properties: Stain guard against oil-based ink maker, fingerprint stain test.

Referring to Table 2, the hard coat sheets based on Examples 1, 3, 5 and 7, and the hard coatings on the surfaces thereof exhibited very good anti-fouling properties and impact resistance as compared to Comparative Example 2, which did not contain the fluoroacrylate copolymer and the acrylic monomer without the cyclic aliphatic structure.

For the hard coat sheet based on Example 6, which was prepared using the perfluoroalkyl group-containing cationic surfactant as the conductive filler, the hard coating on the surface thereof exhibited very good anti-static properties for high processability and printing/deposition properties, good anti-fouling properties for effectively blocking dust or foreign matter from the exterior environment, and good other properties, such as optical properties, film hardness, scratch resistance, and the like, as compared to Comparative Examples 1, which was a general hard coating, and as compared to Comparative Example 2, which was prepared with ATO.

The plastic sheet according to embodiments may exhibit very good anti-fouling properties, impact resistance, anti-static properties, and scratch resistance. Hence, the plastic sheet according to embodiments may be useful for protection filters of various kinds of display devices, protection panels of medical instruments, etc. Moreover, the plastic sheet according to embodiments may afford easy conveyance due to good dispersion stability, storage stability and no requirement for freeze-storage, and may enable easy commercialization due to the low cost of the components.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A sheet with a hard coating, comprising:
a transparent substrate;
a first hard coat layer on a first surface of the transparent substrate, the first hard coat layer including a fluoroacrylate copolymer; and
a second hard coat layer on a second surface of the transparent substrate, the second hard coat layer including a conductive filler in a bisphenol-based polymer.

2. The sheet as claimed in claim 1, wherein the first hard coating is formed from a first hard coating composition that includes:
about 5 to about 50% by weight of the fluoroacrylate copolymer,
about 5 to about 40% by weight of an acrylic monomer,
about 0.1 to about 5% by weight of a photo-initiator, and
an organic solvent as the remaining balance of the weight of the first hard coating composition.

3. The sheet as claimed in claim 2, wherein the acrylic monomer does not have a cyclic aliphatic structure.

4. The sheet as claimed in claim 2, wherein the second hard coating layer is formed from a second hard coating composition that includes:
about 1 to about 15% by weight of a bisphenol-based resin,
about 1 to about 10% by weight of the conductive filler,
about 5 to about 40% by weight of an acrylic monomer,
about 0.1 to about 5% by weight of a photo-initiator, and
an organic solvent as the remaining balance of the weight of the second hard coating composition.

5. The sheet as claimed in claim 4, wherein the second hard coating composition further includes about 1 to about 10% by weight of a thermally resistant resin.

6. The sheet as claimed in claim 5, wherein the thermally resistant resin includes one or more of a polyphenylsilsesquioxane resin, PPZ (a phosphazene-based monomer bearing six methacrylate functional groups), and a blend of PPZ-dipentaerythritol hexacrylate.

7. The sheet as claimed in claim 4, wherein the bisphenol-based resin has a refractive index of about 1.50 or more.

8. The sheet as claimed in claim 7, wherein the first hard coating composition further includes about 1 to about 15% by weight, based on the weight of the first hard coating composition, of a bisphenol-based resin having a refractive index of about 1.50 or more.

9. The sheet as claimed in claim 4, wherein:
the first hard coating composition further includes a photo-stabilizer, and
the second hard coating composition further includes a photo-stabilizer.

10. The sheet as claimed in claim 1, wherein the conductive filler includes one or more of a perfluoroalkyl group-containing cationic surfactant, a polyether/polyolefin block copolymer, a lithium salt, a multifunctional acrylate oligomer with ionic groups, and a poly(3,4-ethylenedioxythiophene)/(polystyrene sulfonate) ethanol dispersion.

11. The sheet as claimed in claim 1, wherein the transparent substrate includes one or more of a polymeric acrylic component, a polymeric polycarbonate component, a polymeric polymethyl methacrylate component, a methyl methacrylate-styrene copolymer component, and a polymeric acrylonitrile butadiene styrene component.

12. The sheet as claimed in claim 11, wherein the transparent substrate includes first and second polymeric acrylic layers, and a polymeric polycarbonate layer between the first and second polymeric acrylic layers.

13. A method of forming a sheet having a hard coating, the method comprising:
forming a first hard coat layer on a first surface of a transparent substrate, the first hard coat layer including a fluoroacrylate copolymer; and
forming a second hard coat layer on a second surface of the transparent substrate, the second hard coat layer including a conductive filler in a bisphenol-based polymer.
